(19) United States
(12) Patent Application Publication
(10) Pub. No.: US 2004/0232696 A1
(43) Pub. Date: Nov. 25, 2004

(54) Pre-assembled sealing connection

(76) Inventor: Maxime Andre, I-Asso (IT)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/488,389

(22) PCT Filed: Sep. 2, 2002
(86) PCT No.: PCT/FR02/02997

(30) Foreign Application Priority Data
Sep. 4, 2001 (FR) 0111405

(51) Int. Cl. F16L 47/00

(52) U.S. Cl. 285/319; 285/307; 285/921

(57) ABSTRACT

The invention provides a pre-assembled coupling for leaktight coupling of a fluid transport tube and an endpiece provided with at least one coupling element. The coupling comprises:

a said tube, which tube presents an annular bead at a front end;

a fastener device slid onto said tube and presenting at least one fastener element complementary to a fastener element of the endpiece; and

an elastomer sealing element disposed around said tube and presenting an inner surface for providing sealing with an outer surface of the tube, and an outer surface for providing sealing with the endpiece.

The invention is particularly suitable for fluid circuits in motor vehicles.

The present invention relates to a pre-assembled leaktight coupling for connecting together in leaktight manner a fluid-transport tube and an endpiece.

### BACKGROUND OF THE INVENTION

Such couplings are already known, e.g. from U.S. Pat. Nos. 4 844 512 or 4 991 882. They comprise a female portion that is snap-fastenable to a male portion constituting the endpiece.

The tube is engaged on a ribbed rear cylindrical region (serrated spigot) of the female portion. The female portion also has two gasket-bearing surfaces for receiving one or two gaskets for providing sealing relative to the endpiece.

Such a coupling is relatively expensive, and in addition it requires two levels of sealing to be provided between the various means, firstly at the rear end between the tube and said rear cylindrical region, and secondly at the front end between the female and male portions.

In addition, the mounting of the tube on the ribbed rear cylindrical region referred to as a serrated spigot is not reliable since it is the result merely of a forced engagement.

For couplings for use in motor vehicle cooling circuits, the quick couplings for tubes that are presently used also require sealing to be provided twice-over, firstly between the tube and the quick coupling, and secondly between the quick coupling and the endpiece, as in the two above-cited patents. Furthermore, those quick couplings are expensive.

Such couplings are produced by the suppliers Norma, Raymond, Legris, John Guest, ITT, etc.

### OBJECTS AND SUMMARY OF THE INVENTION

The invention seeks to simplify the coupling while improving its effectiveness, and in particular to implement a single element that guarantees leaktightness, thereby reducing risks of leakage.

The invention thus provides a pre-assembled coupling for leaktight coupling of a fluid transport tube and an endpiece provided with at least one fastener element, the coupling comprising:

a said tube, which tube presents an annular bead at a front end;

a fastener device slid onto said tube and presenting at least one fastener element complementary to a fastener element of the endpiece; and

an elastomer sealing element disposed around said tube and presenting an inner sealing surface for sealing relative to an outside surface of the tube, and an outer sealing surface for sealing relative to the endpiece.

The fastener device may present at least one grip member exerting a lever effect on a fastener element to enable the coupling to be uncoupled from the endpiece.

The fastener device may present a cylindrical region slidable along the tube. At least one fastener element may be constituted by a snap-fastening arm.

Advantageously, the fastener device presents a face forming a rear abutment for the sealing element. By way of example, this face is plane, but it may be concave, in which case the sealing element has a convex face complementary to said concave face. At least one said snap-fastening arm and/or at least one grip member may be connected to an annular ring.

The invention also provides a leaktight connection between a transport tube and endpiece, the connection being characterized by implementing a coupling as defined above, assembled with the endpiece by co-operation between the fasteners elements of the fastener device and of the endpiece.

The sealing element may be prevented from moving by being held in abutment between the annular bead of the tube and the fastener device.

### BRIEF DESCRIPTION OF THE DRAWINGS

Other characteristics and advantages of the invention appear better on reading the following description given with reference to the accompanying drawings, in which:

FIGS. 1a, 1b, and 1c are longitudinal section views respectively of a coupling constituting a first embodiment of the invention, an endpiece corresponding thereto, and a leaktight connection comprising said coupling mounted on the endpiece by snap-fastening;

FIGS. 2a to 2d show a second embodiment of the coupling of the invention respectively mounted on an endpiece to form a leaktight connection (FIG. 2a), in longitudinal section view of the fastener device (FIG. 2b), a view (FIG. 2c) of the fastener device seen looking along arrow A, and a section view (FIG. 2d) of the sealing element;

FIG. 3 shows a preferred embodiment of a coupling of the invention shown assembled on an endpiece to form a leaktight connection; and

FIGS. 4a and 4b are perspective views of another variant of the coupling of the invention, before and after pre-assembly by being put into abutment.

### MORE DETAILED DESCRIPTION

The invention provides a quick coupling pre-assembled on a rigid or semi-rigid tube 4 (i.e. sufficiently rigid to provide sealing), e.g. made of metal or of plastics material, which tube is shaped at its front end 42 so as to form an annular bead 41. This shaping may be performed cold or hot. An elastomer sealing element 5, e.g. made of rubber, and threaded on the tube 4 (or overmolded thereon) serves to provide sealing against the tube 4 and against the endpiece 3 by compression delivered by a fastener device 6, e.g. made of metal or of thermoplastic material, which is threaded on the tube 4 and which becomes fastened to the endpiece 3 which may be of conventional type, e.g. an endpiece of the kind commonly used by automotive manufacturers in cooling circuits. The fastener device 6 may be threaded onto the tube 4, in particular by force, or it may be overmolded thereon.

The coupling presents various components each corresponding to a function, namely:

a tube 4 for transferring fluid;

an elastomer element 5 for sealing; and

a device 6 for fastening, e.g. by snap-fastening.

Since the coupling is pre-assembled, assembly is performed in a single operation, i.e. merely by snap-fastening.

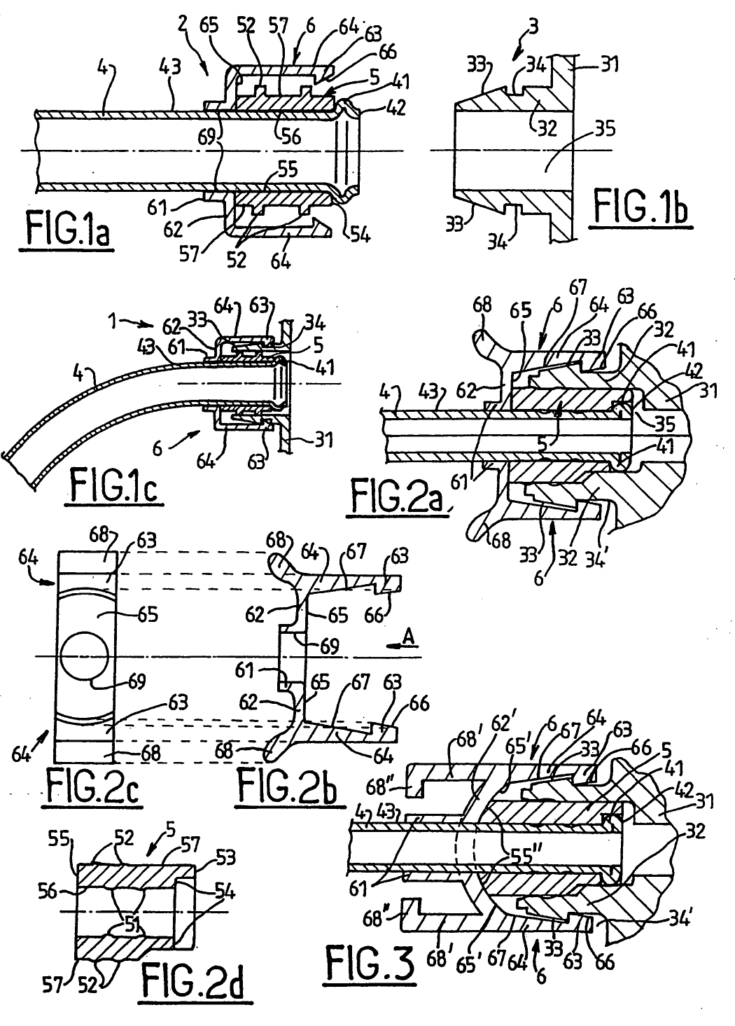

In FIGS. 1a to 1c, the pre-assembled coupling comprises an elastomer sealing element 5 of generally cylindrical shape, whose inner outline 56 is of diameter substantially equal to or slightly less than the diameter of the outer outline 43 of the tube 4, so as to allow it to slide along the tube 4. To improve sealing, the element 5 presents one or more annular beads 51 and/or 52 on its cylindrical outside face 57 and/or on its cylindrical inside face 56. The tube 4 may be shaped so as to enable it to be disengaged by turning through 90°, or through some other angle.

In a variant, the element 5 may be overmolded on the tube 4. The annular bead 41 at the front end of the tube 4 serves as an abutment for the front face 54 of the sealing element 5.

The fastener device 6 presents a cylindrical region 61 whose inner outline 69 is of a diameter suitable for enabling it to slide along the outer outline 43 of the tube 4. The fastener means 6 are constituted, for example, by snap-fastening arms 64, e.g. two arms situated at 180° to each other (as shown in FIG. 2c).

Each arm 64 presents a ramp region 66 for a catch 63 which snaps into a groove 34 of a cylindrical region 32 of the endpiece 3. By way of example, these arms 64 are hinged from an annular ring 62. A front face 65 of the ring 62 and/or of the region 61 serves as a rear abutment for the rear face 55 of the sealing element 5. The ramp region 66 co-operates with a corresponding ramp region 3 of the endpiece 3 so as to facilitate approaching the coupling 2 prior to snap-fastening, which takes place in the position shown in FIG. 1c. In this position, the inside faces 67 of the arms 64 are adjacent to the ramp regions 33.

In this position, the rear and front faces 55 and 54 of the element 5 are in abutment between the face 65 and the bead 41.

The sealing element 5 then performs both desired sealing functions, by means of its inner outline 56 between the tube 4 and the coupling 2, and by means of its outer outline 57 between the coupling 2 and the endpiece 3 provided with a base 31.

In the variant shown in FIGS. 2a to 2d, a grip lug 68 is associated with each arm 64 to enable it to be disengaged from the groove 34′ by the lever effect, slightly deforming the annular ring 62. In this embodiment, the lugs 68 extend outwards from the coupling to make them easier to grip in the hand.

In the variant shown in FIG. 3, the annular ring 62′ (and thus also its front face 65′) is not plane, as in the above-described embodiment, but it is concave with its front face 65′ co-operating with a complementary convex face 55′ of complementary profile of the sealing element 5. By compressing the lugs 68′, this rounded shape facilitates uncoupling the coupling 2 from the endpiece 3.

In addition, the lugs 68′ are extensions to the arms 64 and they themselves present ends 68″ extending towards the region 61, e.g. at 90°.

By coming into abutment, these ends 68″ serve to avoid the lugs 68′ being excessively strained while the coupling 2 is being uncoupled.

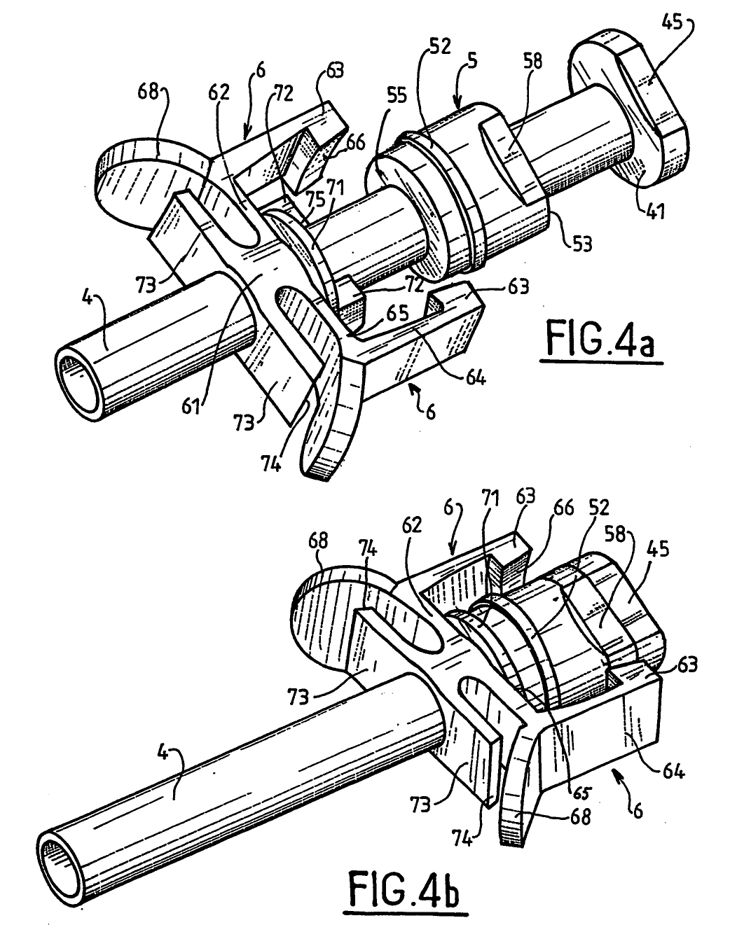

In the variant shown in FIGS. 4a and 4b, the annular end 41 has a flat 45 for angular keying. This can also apply to the gasket 5 by providing it with an end flat 58 facing the flat 45.

The flat 45 serves to guarantee the orientation of the tube (in rotation about its own axis), unlike a serrated spigot which can turn. Such indexing can be independent of the orientation of the intermediate components.

Furthermore, the fastener piece 6 may have a cylindrical ring 71 which is adjacent to the front face 65 and which is extended forwards by two tabs 72 of inner outline 75 suitable for engaging in the perimeter of the gasket 5 downstream from its rear face 55. In the pre-assembled position (FIG. 4b), the front face 73 of the ring 71 is in abutment against the rear face 55 of the gasket 5. The gasket 5 is in abutment via its front face 53 against the annular end 41, and the engagement of the inner outline 75 of the tabs 72 around the gasket serves to prevent the part 6 from turning about the tube 4. This provides angular indexing for the components of the coupling relative to the flat 45, as is required in certain applications where the part 6 needs to be positioned in a precise angular position relative to the flat 45.

In a variant, this angular orientation can be obtained by forced engagement of the part 6 on the tube 4, optionally in association with indexing tabs 72.

The angular indexing by means of the flat 45 enables tube disengagement (at 90° or at some other angle) to be identified angularly for the purpose of mounting the base. There is no need to modify the elements constituting the coupling for this purpose. In other words, a single type of coupling enables any disengagement angle to be used, unlike in the prior art, where it is necessary to adapt the coupling parts.

The invention makes it possible to connect fluid transport tubes (for transporting water, antifreeze, oil, fuel, air, or refrigerant for the air conditioning circuit) more particularly in the automotive field.

Another advantage of the invention is that only the tube 4 and the gasket 5 need to be capable of withstanding the fluid.

The invention can be applied in particular to the circuit for degassing a cooling circuit in a motor vehicle.

What is claimed is:

1. A pre-assembled coupling for leaktight coupling of a fluid transport tube and an endpiece provided with at least one fastener element, the coupling comprising:
a said tube, which tube presents an annular bead at a front end;
a fastener device slid onto said tube and presenting at least one fastener element complementary to a fastener element of the endpiece; and
an elastomer sealing element disposed around said tube and housed between the fastener device and the annular bead, said sealing element presenting an inner sealing surface for sealing relative to an outside surface of the tube, and an outer sealing surface for sealing relative to inner surface of the endpiece.

2. A coupling according to claim 1, wherein the fastener device presents at least one grip member exerting a lever effect on a fastener element to enable the coupling to be uncoupled from the endpiece.

3. A coupling according to claim 1, wherein the fastener device presents a cylindrical region slidable along the tube.

4. A coupling according to claim 1, wherein the fastener device presents a cylindrical region slidable under force along the tube.

5. A coupling according to claim 1, wherein the fastener device presents at least one arm forming a snap-fastening element.

6. A coupling according to claim 1, wherein the fastener device presents a face forming a rear abutment for the sealing element.

7. A coupling according to claim 6, wherein said face is plane.

8. A coupling according to claim 6, wherein said face is concave, and wherein the sealing element presents a convex face complementary to said concave face.

9. A coupling according to claim 5, wherein at least one of said arms is connected to a said annular ring of the fastener device.

10. A coupling according to claim 9, wherein at least one grip member is connected to said annular ring.

11. A coupling according to claim 1, wherein the annular bead and/or the front portion of the gasket presents at its periphery an angular indexing element, in particular a flat.

12. A coupling according to claim 1, wherein the fastener device presents at least one element suitable for being engaged by force against the inner perimeter of the rear portion of the gasket.

13. A coupling according to claim 1, the coupling being pre-assembled with the fastener device being put into abutment against the gasket and with the gasket being put into abutment against the annular bead.

14. A coupling according to claim 12, the coupling being pre-assembled with the fastener device being put into abutment against the gasket and with the gasket being put into abutment against the annular bead, and wherein the fastener device is pre-assembled, being angularly indexed relative to said angular indexing element.

15. A leaktight connection between a transport tube and an endpiece, the connection comprising a coupling according to claim 1 assembled with the endpiece by co-operation between the fastener elements of the fastener device and of the endpiece.

16. A leaktight connection according to claim 15, wherein the sealing element is prevented from moving by being held in abutment between the annular bead of the tube and the fastener device.

17. A leaktight connection according to claim 16, wherein the coupling presents at least one said angular indexing element, and wherein the fastener device is angularly indexed relative to said angular indexing element.
